(19) United States
(12) Patent Application Publication
(10) Pub. No.: US 2023/0045749 A1
(43) Pub. Date: Feb. 9, 2023

(54) SYSTEM AND METHOD OF IMPROVING BRAKING PERFORMANCE DURING FAILURE BY BRAKE-BY-WIRE DEVICE

(71) Applicants: Hyundai Motor Company, Seoul (KR); Kia Corporation, Seoul (KR)

(72) Inventors: Hae Ryong CHOI, Seoul (KR); Dong Yoon HYUN, Seoul (KR)

(73) Assignees: Hyundai Motor Company, Seoul (KR); Kia Corporation, Seoul (KR)

(21) Appl. No.: 17/690,703

(22) Filed: Mar. 9, 2022

(30) Foreign Application Priority Data
Aug. 4, 2021 (KR) 10-2021-0102423

(51) Int. Cl. B60T 8/92; B62D 9/00; B60W 10/20; B60W 10/184; B60W 30/18

(52) U.S. Cl. CPC B60T 8/92; B62D 9/007; B60W 10/20; B60W 10/184; B60W 30/18109; B60T 2270/82; B60T 2270/404; B60T 2260/022; B60T 2260/09; B60W 2510/207; B60W 2510/18; B60W 2710/20; B60W 2710/18

(57) ABSTRACT

A system and a method of improving a braking performance during a failure of a brake-by-wire (BBW) device, includes BBW devices including electro-mechanical brakes provided for respective wheels of a vehicle and independently performing braking, and the BBW devices including controllers electrically connected to the electro-mechanical brakes, and the system includes a steer-by-wire controller configured for controlling front wheels through an electronic signal and a rear wheel steering (RWS) controller configured for controlling steering of rear wheels such that a rear wheel steering angle is to be controlled in the same or an antiphase of a front wheel steering angle, wherein when one of the controllers fails, at least one of the steer-by-wire controller and the RWS controller is configured to control steering based on whether a driver's required braking force exceeds a maximum braking force which may be generated by any one of the front and rear wheels.

### CROSS REFERENCE TO RELATED APPLICATION

The present application claims priority to Korean Patent Application No. 10-2021-0102423, filed Aug. 4, 2021, the entire contents of which is incorporated herein for all purposes by this reference.

### BACKGROUND OF THE INVENTION

### Field of the Invention

The present invention relates to a system and a method of improving a braking performance during a failure of a brake-by-wire (BBW) device, in which the system and the method utilize a steer-by-wire (SBW) controller and a rear wheel steering (RWS) controller configured for maximizing the braking force through BBW devices when any one of the BBW devices fails.

### Description of Related Art

In general, a brake device of a vehicle is a device that generates a braking force desired to decelerate or stop the vehicle in operation or to maintain a stationary state of the vehicle. When the vehicle is decelerated, kinetic energy of the vehicle is converted into thermal energy by mechanical friction, and the frictional heat is discharged into the air such that the vehicle brakes. Such a brake device for a vehicle includes a drum-type hydraulic brake and a disc-type hydraulic brake. The disc-type hydraulic brake acquires a braking force by pressurizing opposite sides of a disc with frictional pads, the disc being rotated with a wheel instead of a drum. However, since the hydraulic brake requires a mechanical element connected to a brake pedal of a driver seat, a hydraulic pipe, and an element of controlling hydraulic pressure, the hydraulic brake has a complex structure. Therefore, to simplify a structure of a brake device, an electro-mechanical brake (EMB) has been developed and implemented.

The BBW (Brake-By-Wire) device including the EMB and a controller therefore is applied to each wheel of the vehicle, controlling the wheels independently. The related art method to cope with a failure of the BBW system is that when the BBW device of any one wheel among four wheels fails, the braking force of the vehicle is generated by controlling all three BBW devices that have not failed to prevent a partial braking. However, since the braking force is generated by the three wheels, a limitation in steering stability performance may occur when in a situation in which the vehicle is rapidly turned. Furthermore, when the braking force of the vehicle is generated by only the BBW devices connected to front wheels or rear wheels to increase the steering stability performance, there may be a problem in that the BBW devices may not generate a required braking force that a driver requires.

The information disclosed in this Background of the Invention section is only for enhancement of understanding of the general background of the invention and may not be taken as an acknowledgement or any form of suggestion that this information forms the prior art already known to a person skilled in the art.

### BRIEF SUMMARY

Various aspects of the present invention are directed to providing a system and a method of improving a braking performance during a failure of a brake-by-wire (BBW) device, in which the system and the method utilize a steer-by-wire (SBW) controller and a rear wheel steering (RWS) controller configured for maximizing the braking force through BBW devices and for preventing a partial braking of a vehicle from occurring when any one of the BBW devices fails.

According to various aspects of the present invention, there is provided a system for improving a braking performance during a failure of a BBW device, the system including: BBW devices including electro-mechanical brakes provided for respective wheels of a vehicle, the electro-mechanical brakes being configured to independently perform braking of the vehicle, and the BBW devices further including controllers electrically connected to the electro-mechanical brakes, respectively; a steer-by-wire (SBW) controller configured to control front wheels of the vehicle through an electronic signal; and a rear wheel steering (RWS) controller configured to control steering of rear wheels of the vehicle so that a steering angle of the rear wheels is controlled in an in-phase or an antiphase of a steering angle of the front wheels, wherein when one of the controllers fails, at least one of the SBW controller and the RWS controller is configured to control steering of the vehicle based on whether a required braking force of a driver exceeds a maximum braking force which may be generated by any one of the front wheels and the rear wheels.

In various exemplary embodiments of the present invention, when the required braking force exceeds the maximum braking force, the controllers may generate a braking force of the vehicle by use of three of remaining electro-mechanical brakes except for an electro-mechanical brake which is connected to the failed controller, among the electro-mechanical brakes.

In various exemplary embodiments of the present invention, at least one of the SBW controller and RWS controller may be configured to control steering of the vehicle to compensate for a partial braking that occurs during braking control through the three electro-mechanical brakes.

In various exemplary embodiments of the present invention, a master controller among the controllers may be configured to determine an understeer determination coefficient according to angles of the front wheels and the rear wheel and a speed difference between the front wheels and the rear wheels, and the SBW controller and the RWS controller may be configured to control steering of the vehicle so that the understeer determination coefficient is converged to zero.

In various exemplary embodiments of the present invention, the master controller may be configured to transmit signals to the SBW controller and the RWS controller, in which the signals are a failure determination signal of one of the controllers and a signal indicative of information on a determination result of the required braking force and the maximum braking force, and information on the understeer determination coefficient.

$$K = \frac{{ω}_{f}}{{C}_{a}} - \frac{{ω}_{r}}{{C}_{a}} {ω}_{f} \\ {ω}_{r} {C}_{a}$$

In various exemplary embodiments of the present invention, when the understeer determination coefficient exceeds zero, the vehicle is in an understeer state, and the RWS controller may perform an antiphase control which is steering the rear wheels in an opposite direction to the front wheels.

In various exemplary embodiments of the present invention, when the understeer determination coefficient is less than zero, the vehicle is in an oversteer state, and the RWS controller may perform the in-phase control which is steering the rear wheels in a same direction to the front wheels.

In various exemplary embodiments of the present invention, an average value of steering angles of left and right wheels of the front wheels may be defined as a normal steering angle, and the SBW controller may independently control steering of the left and right wheels of the front wheels so that the steering angle of each of the left and right wheels of the front wheels is equal to the normal steering angle.

In various exemplary embodiments of the present invention, when the required braking force is equal to or less than the maximum braking force, the controllers may generate a braking force of the vehicle by use of two of the electro-mechanical brakes that are provided at the front wheels or the rear wheels and are configured for normally controlling braking of the vehicle.

In various exemplary embodiments of the present invention, a master controller among the controllers may be configured to stop an operation of the BBW device including a failed controller.

According to various aspects of the present invention, there is provided a method of improving a braking performance during a failure of a BBW device, the method including: determining, by controllers, whether BBW devices have failed, in which the BBW devices include electro-mechanical brakes provided for respective wheels of a vehicle, the electro-mechanical brakes being configured to independently perform braking of the vehicle, and the BBW devices also including the controllers electrically connected to the electro-mechanical brakes, respectively; stopping, by a master controller among the controllers, an operation of the BBW device that has failed; determining and comparing, by the master controller, a maximum braking force according to two of the BBW devices and a required braking force of a driver, in which the two BBW devices are connected to front wheels or rear wheels among the respective wheels where the BBW devices are normally operated; and performing steering control of the vehicle by at least one of a steer-by-wire (SBW) controller and a rear wheel steering (RWS) controller, in which the SBW controller and the RWS controller respectively control steering of the front wheels and the rear wheels based on whether the required braking force exceeds the maximum braking force.

In various exemplary embodiments of the present invention, when the required braking force exceeds the maximum braking force, the controllers may generate a braking force of the vehicle by use of three of remaining electro-mechanical brakes except for an electro-mechanical brake which is connected to the failed controller, among the electro-mechanical brakes.

In various exemplary embodiments of the present invention, the master controller among the controllers may be configured to calculate an understeer determination coefficient according to angles of the front wheels and the rear wheel and a speed difference between the front wheels and the rear wheels, and the SBW controller and the RWS controller may be configured to control steering of the vehicle until the understeer determination coefficient is converged to zero.

In various exemplary embodiments of the present invention, when the understeer determination coefficient exceeds zero, the vehicle is in an understeer state, and the RWS controller may perform an antiphase control which is steering the rear wheels in an opposite direction to the front wheels.

In various exemplary embodiments of the present invention, when the understeer determination coefficient is less than zero, the vehicle is in an oversteer state, and the RWS controller may perform the in-phase control which is steering the rear wheels in a same direction to the front wheels.

In various exemplary embodiments of the present invention, an average value of steering angles of left and right wheels of the front wheels may be defined as a normal steering angle, and the SBW controller may be configured to independently control steering of each of the left and right wheels of the front wheels so that the steering angle of each of the left and right wheels of the front wheels is equal to the normal steering angle.

In various exemplary embodiments of the present invention, when the required braking force is equal to or less than the maximum braking force, the master controller may be configured to generate a braking force of the vehicle by use of two of the electro-mechanical brakes that are provided at the front wheels or the rear wheels and are configured for normally controlling braking of the vehicle.

According to various exemplary embodiments of the present invention, when any one of the BBW devices fails, steering via the RWS controller and the SBW controller may be controlled to prevent a decrease in the maximum braking force and an occurrence of the partial braking generated on the vehicle. While the braking of the vehicle is performed by use of three BBW devices, the RWS controller and the SBW controller may be used to prevent the partial braking which is caused by the using of the three BBW devices. That is, by the integrated control of the RWS controller and the SBW controller, a behavior stability of the vehicle and an improvement in the braking performance may be realized.

According to various exemplary embodiments of the present invention, the RWS controller and the SBW controller may be configured to control the front wheels and the rear wheels of the vehicle by receiving data related to the understeer determination coefficient that enables identifying the partial braking state of the vehicle and adequacy of the steering of the vehicle. That is, by a cooperative control of the BBW device, the RWS controller, and the SBW controller, the generation of the maximum braking force of the vehicle and the compensation for the partial braking which may occur by the generation of the maximum braking force may be simultaneously realized.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a view exemplarily illustrating a vehicle to which a brake-by-wire (BBW) device according to various exemplary embodiments of the present invention is applied;

FIG. 2 is a view exemplarily illustrating a control system of the BBW device according to various exemplary embodiments of the present invention;

FIG. 3 is a view for explaining a method of calculating a normal steering angle according to various exemplary embodiments of the present invention;

FIG. 4 is a flowchart illustrating a method of improving a braking performance of a vehicle during a failure of the BBW device according to various exemplary embodiments of the present invention;

FIG. 5 is a flowchart illustrating a steering control logic of the vehicle by a rear wheel steering (RWS) controller according to various exemplary embodiments of the present invention; and

FIG. 6 is a flowchart illustrating a steering control logic of the vehicle by a steer-by-wire (SBW) controller according to various exemplary embodiments of the present invention.

It may be understood that the appended drawings are not necessarily to scale, presenting a somewhat simplified representation of various features illustrative of the basic principles of the present invention. The specific design features of the present invention as included herein, including, for example, specific dimensions, orientations, locations, and shapes will be determined in part by the particularly intended application and use environment.

In the figures, reference numbers refer to the same or equivalent parts of the present invention throughout the several figures of the drawing.

### DETAILED DESCRIPTION

Reference will now be made in detail to various embodiments of the present invention(s), examples of which are illustrated in the accompanying drawings and described below. While the present invention(s) will be described in conjunction with exemplary embodiments of the present invention, it will be understood that the present description is not intended to limit the present invention(s) to those exemplary embodiments. On the other hand, the present invention(s) is/are intended to cover not only the exemplary embodiments of the present invention, but also various alternatives, modifications, equivalents and other embodiments, which may be included within the spirit and scope of the present invention as defined by the appended claims.

Advantages and features of the present invention, and methods of achieving the advantages and the features, will be apparent from the accompanying drawings and from embodiments that are described in detail below. However, the present invention is not limited to the exemplary embodiments that are included below. Various different embodiments thereof may be realized. The exemplary embodiments are provided to make a complete disclosure of the present inventive concepts and to put a person of ordinary skill in the art to which various exemplary embodiments of the present invention pertains on full notice as to the scope of the present invention. However, the scope of the present invention may be only defined by the claims. Like reference numerals indicate like components throughout the specification.

The terms “ . . . part”, “ . . . unit”, “ . . . module” and the like described herein may mean a unit of processing at least one function or operation, and they may be implemented in hardware, software, or a combination of hardware and software.

Furthermore, the terms “first”, “second” and the like are used herein to divide components in the same relationship but are not necessarily limited to an order in the following description.

The detailed description is for illustrative purpose only. Furthermore, the description provides various exemplary embodiments of the present invention and the present invention may be used in other various combinations, changes, and environments. That is, the present invention may be changed or modified within the scope of the present invention described herein, a range equivalent to the description, and/or within the knowledge or technology in the related art. The exemplary embodiment shows an optimum state for achieving the spirit of the present invention and may be changed in various ways for the detailed application fields and use of the present invention. Therefore, the detailed description of the present invention is not intended to limit the present invention in the exemplary embodiment of the present invention. Furthermore, the claims should be construed as including other embodiments.

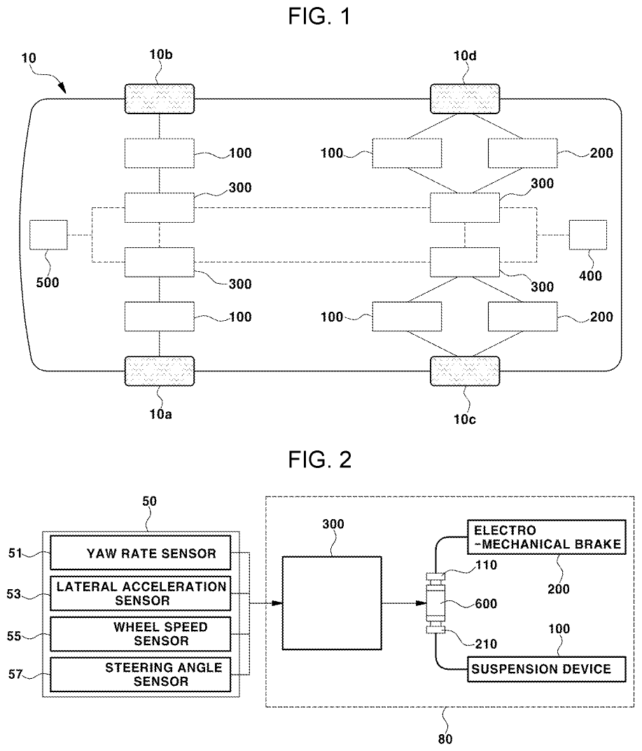

FIG. 1 is a view exemplarily illustrating a vehicle to which a brake-by-wire (BBW) device according to various exemplary embodiments of the present invention is applied.

Referring to FIG. 1, an electro-mechanical brake (EMB) 100 may be applied to each of front wheels 10a and 10b and each of rear wheels 10c and 10d of a vehicle 10. The EMB 100 may refer to a brake that acquires a braking force resulting from pressing a frictional pad by use of a mechanical mechanism driven by an electric motor, unlike a general hydraulic brake. The EMB 100 may press a disc disposed at each of the front wheels 10a and 10b and the rear wheels 10c and 10d by use of a driving force generated by a motor (not illustrated in FIG. 1), and thus the EMB 100 may perform braking of the vehicle 10 by pressing the disc. The EMB 100 is simpler in structure, is faster in response speed, and is configured for performing more accurate control than the hydraulic brake, improving a braking safety performance.

An active suspension device 200 may be applied to each of the rear wheels 10c and 10d of the vehicle 10. In various exemplary embodiments of the present invention, the active suspension device 200 may refer to an active geometry control suspension system (AGCS). The active suspension device 200 may change geometry of a rear suspension for a vehicle by use of an electrically operated motor, and may increase roll steering quantity when the vehicle is turned, increasing a grip force of each of the rear wheels 10c and 10d.

In various exemplary embodiments of the present invention, an EMB system having a suspension control function may include: a single motor (not illustrated in FIG. 1) configured for simultaneously controlling the EMB 100 and the suspension device 200; and a controller 300 for controlling any one of the EMB 100 and the suspension device 200. That is, a single controller 300 may simultaneously control the EMB 100 and the suspension device 200 that are disposed at each of the rear wheels 10c and 10d of the vehicle 10. In the vehicle 10, to which the EMB 100 is applied, the controller 300 may be provided at each of the wheels 10a, 10b, 10c, and 10d, and the controller 300 provided at each of the rear wheels 10c and 10d may simultaneously control the EMB 100 and the suspension device 200. Four controllers 300 may be electrically connected to each other. When any one of the four controllers 300 fails, the controllers 300 that are operated normally may replace the function of the controller 300 which has failed.

When any one controller 300 among BBW devices fails, a problem that braking performance of a vehicle is decreased occurs. Furthermore, when a BBW device connected to any one wheel among the four wheels 10a, 10b, 10c, and 10d fails and the remaining three BBW devices perform braking of the vehicle 10, a partial braking of the vehicle 10 may occur. When only two BBW devices mounted on either the front wheels 10a and 10b or the rear wheels 10c and 10d are operated to prevent the partial braking of the vehicle 10 from occurring, a problem that a maximum braking performance of the vehicle 10 is rapidly decreased occurs. For example, when only two EMB 100 on the front wheels 10a and 10b or the rear wheels 10c and 10d are operated to prevent the partial braking, the maximum braking force of the vehicle 10 may be limited. When a maximum braking force of the normal vehicle 10 is 100%, the maximum braking force using only the front wheels 10a and 10b may be at least about 66% and the maximum braking force using only the rear wheels 10c and 10d may be less than or equal to about 33%. The maximum braking force of the vehicle 10 must be greater than a required braking force of a driver. The required braking force of the driver is proportional to a speed of the vehicle 10, and the speed of the vehicle 10 is proportional to the square of a braking distance of the vehicle 10. However, when the required braking force of the vehicle 10 is large and the maximum braking force of the vehicle 10 is less than the required braking force of the vehicle 10 due to a failure of a braking system of the vehicle 10, the braking distance of the vehicle 10 is increased to the square of the speed of the vehicle 10. Therefore, to improve a braking stability of the vehicle 10 and to improve the braking performance of the vehicle 10, the BBW devices may perform integrated control with a rear wheel steering (RWS) controller 400 and a steer-by-wire (SBW) controller 500.

The RWS controller 400 may control steering of the rear wheels 10c and 10d such that a steering angle of the rear wheels 10c and 10d is to be controlled in the in-phase or an antiphase of a steering angle of the front wheels 10a and 10b. An RWS system which is one of a chassis control system enables steering of the rear wheels 10c and 10d by disposing an actuator at a rear suspension of a vehicle. Furthermore, the RWS system allows a rear wheel steering angle to be controlled in the antiphase of a front wheel steering angle. Therefore, when the vehicle 10 is in a low-speed driving state, a turning radius when the vehicle 10 is turned is lowered. Furthermore, the RWS system allows the rear wheel steering angle to be controlled in the in-phase of the front wheel steering angle. Therefore, stability when the vehicle 10 is turned is improved. The RWS controller 400 may control the steering of the rear wheels 10c and 10d by controlling the actuator which is configured for controlling the rear wheels 10c and 10d of the vehicle 10. The RWS controller 400 may communicate with the controllers 300 of the BBW devices and may receive information, such as whether the controllers 300 have failed, a behavior state of the vehicle 10, and the like, from the controllers 300.

The SBW controller 500 may control the steering of the front wheels 10a and 10b through an electronic signal. An SBW system may refer to a system that removes a mechanical connecting portion between a steering wheel and a front wheel tire and steers the steering wheel by connecting therebetween with the electronic signal. Since an existing mechanical connection structure is removed, the SBW system may have advantages such as increased freedom in relation to design a steering system, improved fuel efficiency, high resistance to disturbances, and the like. However, as the mechanical connection structure is removed, the driver is unable to receive a feedback related to steering information, so that a steering reaction force or a restoring reaction force is generated by use of a spring or a motor. A reaction force motor is provided on a steering column to assist the driver's operating force of the steering wheel. The wheels on the left and right sides of the vehicle 10 are separated from each other and are independent, and are connected to each ball screw through tie rods and control levers. Furthermore, the ball screw is connected to a rack motor to move in a straight line by receiving a rotational power of the rack motor. The reaction force motor and the rack motor are each connected to an output end portion of the SBW controller 500, and are optionally driven by a control signal applied from the SBW controller 500. The SBW controller 500 may communicate with the controllers 300 of the BBW devices and may receive information, such as whether the controllers 300 have failed, a behavior state of the vehicle 10, and the like, from the controllers 300. Furthermore, the SBW controller 500 may communicate with the RWS controller 400. The SBW controller 500 may transmit steering angle information of the front wheels 10a and 10b to the RWS controller 400, and the RWS controller 400 may transmit steering angle information of the rear wheels 10c and 10d to the SBW controller 500.

Unlike the example described above, a motor driven power steering (MDPS) system may control the steering of the front wheels 10a and 10b. An MDPS controller of the MDPS system may receive information, such as whether the controllers 300 have failed, a behavior state of the vehicle 10, and the like, from the controllers 300.

Any one of the controllers 300 may be selected as a master controller. The master controller may be a preselected controller before the vehicle 10 turns an ignition on. When the master controller fails, any one controller among the controllers 300 that have not failed may be selected as a new master controller.

A plurality of controllers 300 may communicate with each other, and each controller 300 may determine whether at least one of the controllers 300 fails, by determining whether data is transmitted and received, by determining reliability of data which is transmitted and received, and the like.

For an example, the controllers 300 may determine that a failure has occurred in a controller 300 which does not transmit or receive data within a predetermined time period. Each of the controllers 300 may transmit a variable value in which a counter thereof is increased according to a cycle, to the remaining controllers 300. However, the failed controllers 300 may not transmit the variable value. Furthermore, an increment state of the counter of the variable value which is transmitted by the failed controllers 300 and an increment state of the counter of the variable value which is transmitted by operated normally controllers 300 may be different from each other. Each of the controllers 300 may determine which controller 300 has failed, by comparing and determining the increment states of the variable values received from the other controllers 300.

When any one controller 300 among the controllers 300 fails, the master controller among the controllers 300 may determine whether the required braking force of the driver exceeds the maximum braking force which may be generated by either the front wheels 10a and 10b or the rear wheels 10c and 10d. When the required braking force exceeds the maximum braking force, at least one of controller among the SBW controller 500 or the RWS controller 400 may control the steering of the vehicle 10. At the instant time, the maximum braking force may refer to the braking force of the vehicle 10 using the remaining two BBW devices except for the BBW devices positioned on a side to which the failed controller 300 is connected among the front wheels 10a and 10b or the rear wheels 10c and 10d. The master controller may transmit signals to the SBW controller 500 and the RWS controller 400, in which the signals are a failure determination signal of one of the controllers 300 and a signal including a calculation result of the required braking force and the maximum braking force. The RWS controller 400 and the SBW controller 500 may control the steering of the front wheels 10a and 10b and the rear wheels 10c and 10d to increase the maximum braking force of the vehicle 10 and to prevent the partial braking which may occur on the vehicle 10. A steering control method by use of the RWS controller 400 and the SBW controller 500 will be described later.

According to various exemplary embodiments of the present invention, to prevent a decrease in the maximum braking force and to prevent the partial braking which is occurred on the vehicle 10 when any one among the BBW devices fails (specifically, a failure of any one of the controllers 300), the steering through the RWS controller 400 and the SBW controller 500 may be controlled. While the braking of the vehicle 10 is performed by use of three BBW devices, the RWS controller 400 and the SBW controller 500 may be used to prevent the partial braking which is caused by the using of the three BBW devices. That is, by the integrated control of the RWS controller 400 and the SBW controller 500, behavior stability of the vehicle 10 and an improvement in the braking performance may be realized.

FIG. 2 is a view exemplarily illustrating a control system of the BBW device according to various exemplary embodiments of the present invention.

Referring to FIG. 1 and FIG. 2, a braking system of a vehicle using a BBW device 80 may include a sensor unit 50, the controller 300, and the BBW device 80. The BBW device 80 may include the EMB 100, the suspension device 200, and the controller 300. However, the suspension device 200 may only be applied to the BBW device 80 which is applied to the rear wheels 10c and 10d of the vehicle 10.

The sensor unit 50 may include a yaw rate sensor 51, a lateral acceleration sensor 53, a wheel speed sensor 55, and a steering angle sensor 57. The sensor unit 50 may detect an operation state of the BBW device 80. At the instant time, the operation state of the BBW device 80 may include a force applied to the wheels 10a, 10b, 10c, and 10d by the BBW device 80, a speed and a steering of the wheels 10a, 10b, 10c, and 10d, and the like. The sensor unit 50 may be disposed on each wheel 10a, 10b, 10c, and 10d. Information of the vehicle 10 detected by the sensor unit 50 may be transmitted to the controller 300.

The yaw rate sensor 51 may detect a changing speed of a rotational angle (a yaw angle) around a perpendicular line passing through the center portion of the vehicle 10. The yaw rate sensor 51 may detect a change in the behavior of the vehicle 10 in a yaw direction due to steering change or braking.

The lateral acceleration sensor 53 may detect acceleration of the vehicle 10 which is changed in a lateral direction thereof. In various exemplary embodiments of the present invention, the lateral acceleration sensor 53 may detect a change in the behavior of the vehicle 10 in the lateral direction due to steering change or braking.

The wheel speed sensor 55 may detect a change in speed of the vehicle 10 in a longitudinal direction thereof. The wheel speed sensor 55 may be disposed at each of the front wheels 10a and 10b and the rear wheels 10c and 10d of the vehicle 10. That is, the wheel speed sensor 55 may detect the speed of the front wheels 10a and 10b and the speed of the rear wheels 10c and 10d.

The steering angle sensor 57 may detect a change in steering of the vehicle 10. That the steering angle sensor 57 detects a change in steering of the vehicle 10 may refer to that a driver of the vehicle 10 has changed steering. In various exemplary embodiments of the present invention, the steering angle sensor 57 may detect whether the vehicle 10 has been abruptly steered.

Unlike the example described above, the sensor unit 50 may include a camera, a radar, and a Light Detection and Ranging (LiDAR) that are for determining whether the vehicle 10 has been abruptly steered and abruptly braked. Furthermore, the sensor unit 50 may include a brake position sensor (BPS) which may determine braking intention of the driver.

The controller 300 may estimate the state of the vehicle 10 based on the information of the vehicle 10 transmitted by the sensor unit 50, and may output a control signal for controlling the BBW device 80 based on the state of the vehicle 10. The controller 300 may analyze the information of the vehicle 10 transmitted by the sensor unit 50 and determine the state of the vehicle 10, and may output a control signal based on the state of the vehicle 10.

The controller 300 may determine whether the vehicle 10 is normally driving, has been abruptly steered, or has been abruptly braked.

The controller 300 may output a first control signal for generating output desired for the motor 600 and a second control signal for physically coupling a first clutch 110 and a second clutch 210 to the motor 600. The controller 300 may apply the second control signal to any one of the first clutch 110 and the second clutch 210 based on a state signal of the vehicle 10. When the second control signal is applied to the first clutch 110, the first clutch 110 may be physically coupled to a shaft of the motor 600. Consequently, the rotational force of the motor 600 may be transmitted to the EMB 100. When the second control signal is applied to the second clutch 210, the second clutch 210 may be physically coupled to the shaft of the motor 600. Consequently, the rotational force of the motor 600 may be transmitted to the suspension device 200.

When the sensor unit 50 fails, the controller 300 may secure the stability of the vehicle 10 by controlling the BBW devices 80 mounted on each wheel 10a, 10b, 10c, and 10d. When it is determined that any one of the sensor units 50 mounted on each wheel 10a, 10b, 10c, and 10d has failed, the controller 300 may turn-off any one BBW device 80 that has been detected by the failed sensor unit 50. In other words, the controller 300 may turn-off the BBW device 80 disposed on the wheels 10a, 10b, 10c, and 10d on which the failed sensor unit 50 is disposed. Accordingly, the controller 300 may perform controlling of the braking or the suspension of the BBW devices 80 based on a driving state of the vehicle 10. The driving state of the vehicle 10 may refer to a condition of the vehicle, in which the condition of the vehicle is whether the vehicle 10 is in an understeer condition, is in an oversteer condition, or is in a normal condition.

According to various exemplary embodiments of the present invention, to secure the stability of the vehicle 10, the controller 300 may perform controlling of the braking or the suspension of the BBW devices 80 based on whether the sensor unit 50 has failed and based on the driving state of the vehicle 10. The controller 300 turns-off the BBW device 80 positioned at the failed sensor unit 50, so that the controller 300 may be prevented from controlling the wheels 10a, 10b, 10c, and 10d based on faulty data.

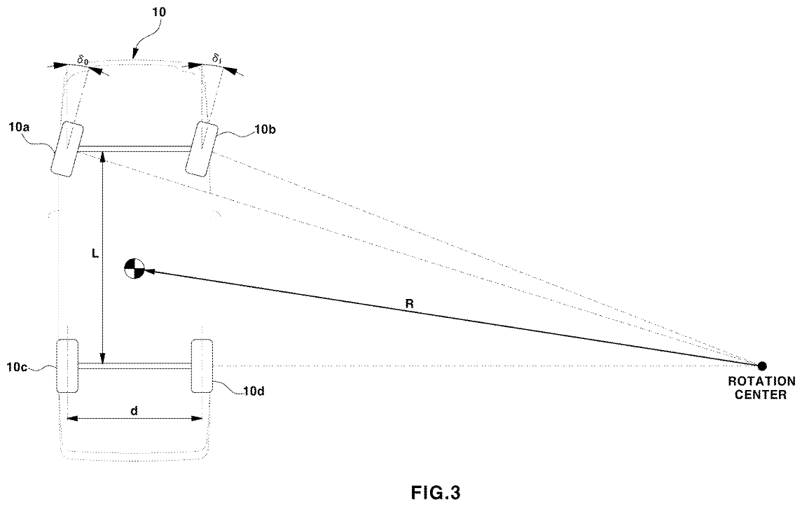

FIG. 3 is a view for explaining a method of calculating a normal steering angle according to various exemplary embodiments of the present invention.

Referring to FIG. 3, when the BBW device 80 fails, the controller 300 may calculate a tire angle in the normal driving condition to determine a pulling of the vehicle 10 by the partial braking. Furthermore, although the BBW device 80 fails, the controller 300 may determine whether the partial braking has occurred, by determining a steering state according to a difference of tire speeds.

First, it is regarded that a steering angle in a normal driving situation is the same as an Ackermann angle based on vehicle dynamics theory. Assuming that the vehicle 10 is turned to the right direction, an average value of the steering angles of left and right front wheels 10a and 10b is defined as the Ackermann angle, and the Ackermann angle may be determined based on the steering angle when the vehicle 10 is in the normal driving state.

$${δ}_{0} = \frac{L}{R + \frac{d}{2}} \\ {δ}_{i} = \frac{L}{R - \frac{d}{2}} \\ δ = \frac{L}{R} \\ {δ}_{0} {δ}_{i} \\ δ$$

In various exemplary embodiments of the present invention, the Ackerman angle is the ideal steering angle, and may be defined as the normal steering angle. The normal steering angle is a parameter used in the steering control via the SBW system which is described later, and the SBW system may independently control each front wheel 10a and 10b by determining a rack displacement which is a degree to which the steering angle of the front wheels 10a and 10b has deviated from the compared normal steering angle.

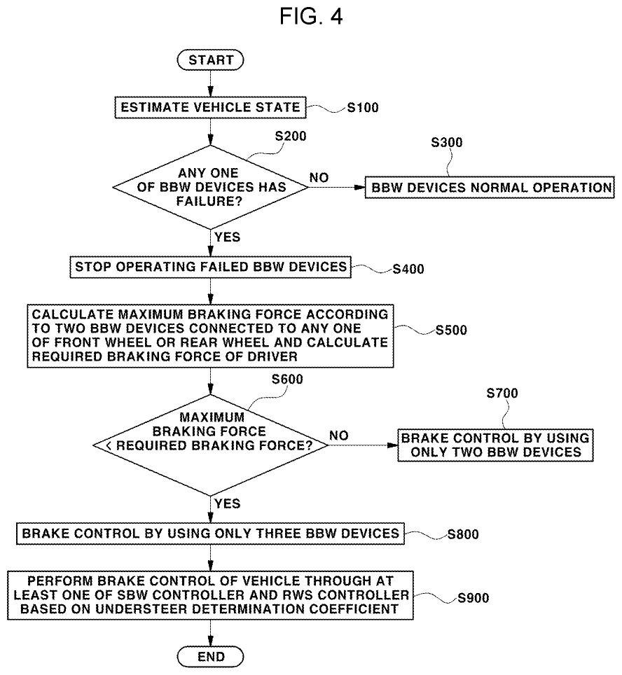

FIG. 4 is a flowchart illustrating a method of improving a braking performance of a vehicle during a failure of the BBW device according to various exemplary embodiments of the present invention.

Referring to FIG. 1, FIG. 2, FIG. 3, and FIG. 4, the controllers 300 which is a component of the BBW devices 80 may estimate the behavior state of the vehicle 10 through data, such as the yaw rate, the vehicle speed, the steering angle, the lateral acceleration, and the like, acquired by the plurality of sensors 51, 53, 55, and 57 that are mounted on the vehicle 10. (S100)

The controllers 300 may identify which controller 300 has failed, by transmitting and receiving data between the controllers 300. Furthermore, with a separate sensor, the controller 300 may identify whether the BBW device 80 including the EMB 100 and the suspension device 200 has failed. (S200).

When a failure of the BBW device 80 does not occur, the BBW device 80 may generate a braking force more than a braking force that a driver requires. Therefore, the BBW device 80 may be normally operated. (S300)

When the failure of the BBW device 80 occurs, the master controller among the controllers 300 may stop an operation of the BBW device 80 including the failed controller 300. When the failure of the BBW device 80 including the master controller occurs, a master authority of the master controller may be delegated to the controller 300 having a second priority which is predetermined. (S400)

The master controller may be configured to calculate both the maximum braking force generated by the two BBW devices 80 that are connected to any one of the front wheels 10a and 10b or the rear wheels 10c and 10d and the required braking force of the driver. The calculation result of the required braking force and the maximum braking force may be transmitted from the master controller to other controllers 300. (S500)

The master controller may be configured to determine whether the required braking force exceeds the maximum braking force. The master controller may transmit a comparison result between the required braking force and the maximum braking force to other controllers 300, the RWS controller 400, and the SBW controller 500. (S600)

When the required braking force does not exceed the maximum braking force, the master controller may be configured to generate the braking force of the vehicle 10 by only using two BBW devices 80. That the required braking force does not exceed the maximum braking force may refer to that the vehicle 10 may be stably braked by the braking force generated by the BBW devices 80 (or the EMB 100) connected to the operated normally front wheels 10a and 10b or the rear wheels 10c and 10d. (S700)

When the required braking force exceeds the maximum braking force, the master controller may be configured to generate the braking force of the vehicle 10 by use of all three BBW devices 80 except for the failed BBW device 80. That the required braking force exceeds the maximum braking force may refer to that the vehicle 10 may be difficult to be stably braked with the braking force generated by the BBW devices 80 (or the EMB 100) connected to the operated normally front wheels 10a and 10b or the rear wheels 10c and 10d. Therefore, the master controller may be configured to generate the braking force of the vehicle 10 by use of the remaining three EMB 100 except for the EMB 100 connected to the failed controller 300. (S800)

The master controller may be configured to calculate an understeer determination coefficient on the basis of angles of the wheels 10a, 10b, 10c, and 10d and a speed difference between the front wheels 10a and 10b and the rear wheels 10c and 10d among the wheels 10a, 10b, 10c, and 10d. The understeer determination coefficient is a parameter that enables identification of the occurrence of the partial braking on the vehicle 10. That the understeer determination coefficient is zero may refer to that the partial braking has not occurred. The understeer determination coefficient may be calculated as follows:

$$K = \frac{{ω}_{f}}{{C}_{a}} - \frac{{ω}_{r}}{{C}_{a}}$$

At the present time, ω_{f} may denote a front wheel speed, ω_{f} may denote a rear wheel speed, C_{α} may denote a cornering stiffness, and K may denote the understeer determination coefficient. The cornering stiffness may refer to a differential value at which a side force occurs at a slip angle of zero degrees according to the relationship between the slip angle and the side force, in which the slip angle refers to an angle between a direction of the tire and a center portion surface of the tire. At the instant time, the side force may refer to a force acting perpendicular to the center portion surface of the tire that rolls with the slip angle. The master controller may transmit the calculated understeer determination coefficient to the RWS controller 400 and the SBW controller 500. At least one among the SBW controller 500 or the RWS controller 400 may control the steering of the vehicle 10 so that the understeer determination coefficient converges to zero. In other words, at least one among the SBW controller 500 or the RWS controller 400 may control the steering of the vehicle 10 to compensate for the partial braking that occurs during braking control through the three EMB 100.

According to various exemplary embodiments of the present invention, the RWS controller 400 and the SBW controller 500 may control the front wheels 10a and 10b and the rear wheels 10c and 10d of the vehicle 10 by receiving data related to the understeer determination coefficient that enables identification of the partial braking state of the vehicle 10 and adequacy of the steering of the vehicle 10. That is, by the cooperative control of the BBW device 80, the RWS controller 400, and the SBW controller 500, the generation of the maximum braking force of the vehicle 10 and the compensation for the partial braking which may occur by the generation of the maximum braking force may be simultaneously realized.

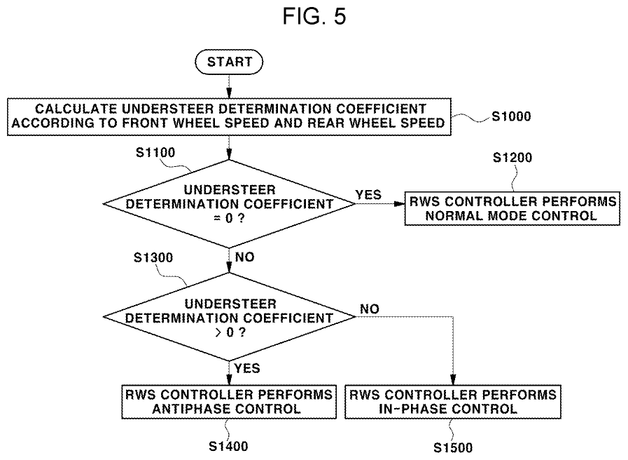

FIG. 5 is a flowchart illustrating a steering control logic of the vehicle through a rear wheel steering (RWS) controller according to various exemplary embodiments of the present invention.

Referring to FIG. 1, FIG. 2, FIG. 3, FIG. 4, and FIG. 5, the master controller may be configured to determine the understeer determination coefficient on the basis of a speed difference between the speed of the front wheels 10a and 10b and the speed of the rear wheels 10c and 10d. (S1000)

That the understeer determination coefficient is zero may refer to that the partial braking does not occur on the vehicle 10. Therefore, the RWS controller 400 may be controlled in a normal mode. That is, the RWS controller 400 does not control the rear wheels 10c and 10d through the cooperative control with the BBW device 80, and the RWS controller 400 may control the rear wheels 10c and 10d in the normal mode which is performed when the vehicle 10 is in the normal driving state. (S1100, s1200)

When the understeer determination coefficient is greater than zero, the master controller may be configured to determine that the vehicle 10 is in an understeer state. The RWS controller 400 may perform an antiphase control which is steering the rear wheels 10c and 10d in an opposite direction to the front wheels 10a and 10b. The RWS controller 400 may perform the antiphase control until the understeer determination coefficient determined in real time to be zero. (S1300, s1400)

When the understeer determination coefficient is less than zero, the master controller may be configured to determine that the vehicle 10 is in an oversteer state. The RWS controller 400 may perform the in-phase control which is steering the rear wheels 10c and 10d in the same direction to the front wheels 10a and 10b. The RWS controller 400 may perform the antiphase control until the understeer determination coefficient calculated in real time becomes zero. (S1500)

According to various exemplary embodiments of the present invention, the in-phase control of the RWS controller 400 may generate an effect of relieving an oversteer situation of the vehicle 10, and the antiphase control of the RWS controller 400 may realize an effect of a rapid steering compensation that the understeer determination coefficient rapidly becomes zero.

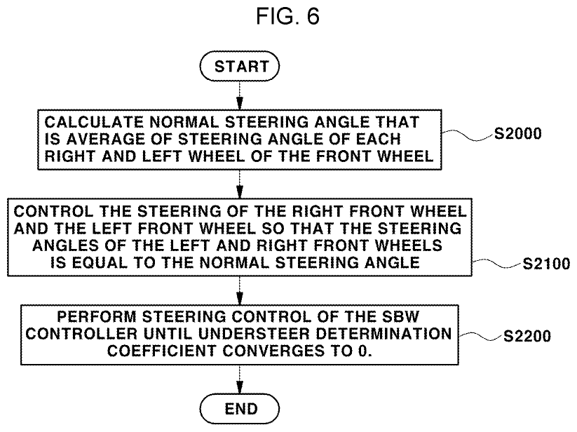

FIG. 6 is a flowchart illustrating a steering control logic of the vehicle by a steer-by-wire (SBW) controller according to various exemplary embodiments of the present invention.

Referring to FIGS. 1 and 6, the master controller may be configured to calculate the normal steering angle which is the average of each steering angle of the right front wheel 10b and the left front wheel 10a. (S2000)

The SBW controller 500 may independently control the steering of the right front wheel 10b and the left front wheel 10a so that the steering angles of the left and right front wheels 10b and 10a is equal to the normal steering angle. (S2100)

The SBW controller 500 may perform controlling steering of the front wheels 10a and 10b until the understeer determination coefficient calculated in real time becomes zero. (S2200)

According to various exemplary embodiments of the present invention, the control of the rear wheels 10c and 10d by the RWS controller 400 and the control of the front wheels 10a and 10b by the SBW controller 500 may be simultaneously performed. Furthermore, only one of the control of the rear wheels 10c and 10d by the RWS controller 400 and the control of the front wheels 10a and 10b by the SBW controller 500 may be performed. Furthermore, the control of the front wheels 10a and 10b by the SBW controller 500 may be replaced by the MDPS system.

Furthermore, the term related to a control device such as “controller”, “control unit”, “control device” or “control module”, etc refers to a hardware device including a memory and a processor configured to execute one or more steps interpreted as an algorithm structure. The memory stores algorithm steps, and the processor executes the algorithm steps to perform one or more processes of a method in accordance with various exemplary embodiments of the present invention. The control device according to exemplary embodiments of the present invention may be implemented through a nonvolatile memory configured to store algorithms for controlling operation of various components of a vehicle or data about software commands for executing the algorithms, and a processor configured to perform operation to be described above using the data stored in the memory. The memory and the processor may be individual chips. Alternatively, the memory and the processor may be integrated in a single chip. The processor may be implemented as one or more processors. The processor may include various logic circuits and operation circuits, may process data according to a program provided from the memory, and may generate a control signal according to the processing result.

The control device may be at least one microprocessor operated by a predetermined program which may include a series of commands for carrying out the method included in the aforementioned various exemplary embodiments of the present invention.

The aforementioned invention can also be embodied as computer readable codes on a computer readable recording medium. The computer readable recording medium is any data storage device that can store data which may be thereafter read by a computer system. Examples of the computer readable recording medium include hard disk drive (HDD), solid state disk (SSD), silicon disk drive (SDD), read-only memory (ROM), random-access memory (RAM), CD-ROMs, optical data storage devices, etc and implementation as carrier waves (e.g., transmission over the Internet).

In various exemplary embodiments of the present invention, each operation described above may be performed by a control device, and the control device may be configured by a plurality of control devices, or an integrated single control device.

In various exemplary embodiments of the present invention, the control device may be implemented in a form of hardware or software, or may be implemented in a combination of hardware and software.

For convenience in explanation and accurate definition in the appended claims, the terms “upper”, “lower”, “inner”, “outer”, “up”, “down”, “upwards”, “downwards”, “front”, “rear”, “back”, “inside”, “outside”, “inwardly”, “outwardly”, “interior”, “exterior”, “internal”, “external”, “forwards”, and “backwards” are used to describe features of the exemplary embodiments with reference to the positions of such features as displayed in the figures. It will be further understood that the term “connect” or its derivatives refer both to direct and indirect connection.

The foregoing descriptions of specific exemplary embodiments of the present invention have been presented for purposes of illustration and description. They are not intended to be exhaustive or to limit the present invention to the precise forms disclosed, and obviously many modifications and variations are possible in light of the above teachings. The exemplary embodiments were chosen and described to explain certain principles of the present invention and their practical application, to enable others skilled in the art to make and utilize various exemplary embodiments of the present invention, as well as various alternatives and modifications thereof. It is intended that the scope of the present invention be defined by the Claims appended hereto and their equivalents.

What is claimed is:

1. A system for improving a braking performance during a failure of a brake-by-wire (BBW) device, the system comprising:
BBW devices including electro-mechanical brakes provided for respective wheels of a vehicle, the electro-mechanical brakes being configured to independently perform braking of the vehicle, and the BBW devices further including controllers electrically connected to the electro-mechanical brakes, respectively;
a steer-by-wire (SBW) controller configured to control front wheels of the vehicle through an electronic signal; and
a rear wheel steering (RWS) controller configured to control steering of rear wheels of the vehicle so that a steering angle of the rear wheels is controlled in an in-phase or an antiphase of a steering angle of the front wheels,
wherein when one of the controllers fails, at least one of the SBW controller and the RWS controller is configured to control steering of the vehicle based on whether a required braking force of a driver exceeds a maximum braking force that is generated by one of the front wheels and the rear wheels.

2. The system of claim 1, wherein when the required braking force exceeds the maximum braking force, the controllers are configured to generate a braking force of the vehicle by use of three remaining electro-mechanical brakes except for an electro-mechanical brake which is connected to the failed controller, among the electro-mechanical brakes.

3. The system of claim 2, wherein at least one of the SBW controller and RWS controller is configured to control steering of the vehicle to compensate for a partial braking that occurs during braking control through the three electro-mechanical brakes.

4. The system of claim 3,
wherein a master controller among the controllers is configured to determine an understeer determination coefficient according to angles of the front wheels and the rear wheel and a speed difference between the front wheels and the rear wheels, and
wherein the SBW controller and the RWS controller are configured to control the steering of the vehicle so that the understeer determination coefficient is converged to zero.

5. The system of claim 4, wherein the master controller is configured to transmit signals to the SBW controller and the RWS controller, in which the signals are a failure determination signal of one of the controllers and a signal indicative of information on a determination result of the required braking force and the maximum braking force, and information on the understeer determination coefficient.
$$K = \frac{{ω}_{f}}{{C}_{a}} - \frac{{ω}_{r}}{{C}_{a}} {ω}_{f} {ω}_{r} \\ {C}_{a}$$

7. The system of claim 4, wherein when the understeer determination coefficient exceeds zero, the vehicle is in an understeer state, and the RWS controller is configured to perform an antiphase control which is steering the rear wheels in an opposite direction to the front wheels.

8. The system of claim 4, wherein when the understeer determination coefficient is less than zero, the vehicle is in an oversteer state, and the RWS controller is configured to perform an in-phase control which is steering the rear wheels in a same direction to the front wheels.

9. The system of claim 4, wherein an average value of steering angles of left and right wheels of the front wheels is defined as a normal steering angle, and the SBW controller is configured to independently control steering of the left and right wheels of the front wheels so that the steering angle of each of the left and right wheels of the front wheels is equal to the normal steering angle.

10. The system of claim 1, wherein when the required braking force is equal to or less than the maximum braking force, the controllers are configured to generate a braking force of the vehicle by use of two electro-mechanical brakes that are provided at the front wheels or the rear wheels, among the electro-mechanical brakes and are configured for normally controlling braking of the vehicle.

11. The system of claim 1, wherein a master controller among the controllers is configured to stop an operation of the BBW device including a failed controller.

12. A method of improving a braking performance during a failure of a brake-by-wire (BBW) device, the method including:
determining, by controllers, whether BBW devices have failed, wherein the BBW devices include electro-mechanical brakes provided for respective wheels of a vehicle, the electro-mechanical brakes are configured to independently perform braking of the vehicle, and the BBW devices further includes the controllers electrically connected to the electro-mechanical brakes, respectively;
stopping, by a master controller among the controllers, an operation of the BBW device that has failed;
determining and comparing, by the master controller, a maximum braking force according to two of the BBW devices and a required braking force of a driver, wherein the two BBW devices are connected to front wheels or rear wheels among the respective wheels where the BBW devices are normally operated; and
performing steering control of the vehicle by at least one of a steer-by-wire (SBW) controller and a rear wheel steering (RWS) controller, in which the SBW controller and the RWS controller respectively control steering of the front wheels and the rear wheels based on whether the required braking force exceeds the maximum braking force.

13. The method of claim 12, wherein when the required braking force exceeds the maximum braking force, the controllers are configured to generate a braking force of the vehicle by use of three remaining electro-mechanical brakes except for an electro-mechanical brake which is connected to the failed controller, among the electro-mechanical brakes.

14. The method of claim 13,
wherein the master controller among the controllers is configured to determine an understeer determination coefficient according to angles of the front wheels and the rear wheel and a speed difference between the front wheels and the rear wheels, and
wherein the SBW controller and the RWS controller are configured to control steering of the vehicle until the understeer determination coefficient is converged to zero.
$$K = \frac{{ω}_{f}}{{C}_{a}} - \frac{{ω}_{r}}{{C}_{a}} {ω}_{f} {ω}_{r} \\ {C}_{a}$$

16. The method of claim 14, wherein when the understeer determination coefficient exceeds zero, the vehicle is in an understeer state, and the RWS controller is configured to perform an antiphase control which is steering the rear wheels in an opposite direction to the front wheels.

17. The method of claim 14, wherein when the understeer determination coefficient is less than zero, the vehicle is in an oversteer state, and the RWS controller is configured to perform an in-phase control which is steering the rear wheels in a same direction to the front wheels.

18. The method of claim 13, wherein an average value of steering angles of left and right wheels of the front wheels is defined as a normal steering angle, and the SBW controller is configured to independently control steering of each of the left and right wheels of the front wheels so that the steering angle of each of the left and right wheels of the front wheels is equal to the normal steering angle.

19. The method of claim 12, wherein when the required braking force is equal to or less than the maximum braking force, the master controller is configured to generate a braking force of the vehicle by use of two electro-mechanical brakes that are provided at the front wheels or the rear wheels, among the electro-mechanical brakes, and are configured for normally controlling braking of the vehicle.

20. A non-transitory computer readable storage medium on which a program for performing the method of claim 12 is recorded.
